(19) United States
(12) Patent Application Publication
(10) Pub. No.: US 2005/0047406 A1
(43) Pub. Date: Mar. 3, 2005

(54) Nested components for network protocols

(76) Inventor: Susan Hares, Saline, MI (US)

Correspondence Address: PERKINS COIE LLP, P.O. BOX 2168, MENLO PARK, CA, 94026, US

(21) Appl. No.: 10/648,146

(22) Filed: Aug. 25, 2003

(51) Int. Cl. H04L 12/56

(52) U.S. Cl. 370/389

(57) ABSTRACT

Protocols, data structures, algorithms, architectures, and methodologies are described for securing, compressing, and transmitting data in networks. The invention includes data structures for transmission in networks referred to as “network components.” Network components may form nested structures, and may be processed recursively. Features supported by network components, which perform multiple functions including (1) reducing the data exchanged in networks by replacing repeating information with identification numbers and (2) securing data sent in networks at a detailed level of granularity. Network components also allow the use of link-state protocols for supporting large Network Information Bases, such as BGP. Formats of network components may be constructed and/or altered in real-time, or determined from protocol definitions by automated techniques.

### CROSS-REFERENCE TO RELATED APPLICATION(S)

This application is related to U.S. Provisional Application No. 60/390,576, entitled “Fibonacci Heap for Use with Internet Routing Protocols,” U.S. Utility application entitled “Fibonacci Heap for Use with Internet Routing Protocols,” U.S. Utility application entitled “Systems and Methods for Routing Employing Link State and Path Vector Techniques,” filed on the same day herewith, and U.S. Utility application entitled “Nested Components for Network Protocols,” also filed on the same day herewith, each of which is hereby incorporated by reference in its entirety.

### TECHNICAL FIELD

This application relates to the field of communications networks, and more particularly, to protocols and algorithms deployed in packet-switched networks.

### BACKGROUND

In communications networks such as the Internet, information is transmitted in the form of packets. A packet comprises a unit of digital information that is individually routed hop-by-hop from a source to destination. The routing of a packet entails that each node, or router, along a path traversed by the packet examines header information in the packet, to compare this header against a local database; upon consulting the local database, the router forwards the packet to an appropriate next hop. The local database is typically referred to as the Forwarding Information Base or FIB; the FIB is typically structured as a table, but may be instantiated in alternative formats. Entries in the FIB determine the next hop for the packet, i.e., the next router, or node, to which the respective packets are forwarded in order to reach the appropriate destination. The Forwarding information Bases are usually derived from global or network-wide information from a collective database. Each protocol names the collective databases to denote the type of information. Such databases are referred to generically herein as Network Information Databases (NIBs).

In implementations of the Internet Protocol (IP), the FIB is typically derived from a collective database, i.e., a NIB, referred to as a Routing Information Database or RIB. A RIB resident on a router amalgamates the routing information available to that router; one or more algorithms are typically used to map the entries, e.g., routes, in the RIB to those in the FIB, which, in turn, is used for forwarding packets to their next hop. The IP RIB may be constructed by use of two techniques, which may be used in conjunction: (a) static configuration and (b) dynamic routing protocols. Dynamic IP routing protocols may be further subdivided into two groups based on the part of the Internet in which they operate: exterior gateway protocols, or EGPs, are responsible for the dissemination of routing data between autonomous administrative domains, and interior gateway protocols, or IGPs, are responsible for dissemination of routing data within a single autonomous domain. Furthermore, two types of IGPs are in widespread use today: those that use a distance-vector type of algorithm and those that use the link-state method.

Each type of protocol typically formats packets either in a pre-defined byte order, or by reference to a dynamically generated definition of the information contained in the packet. Dynamic definitions of data formats often employ a three part definition for a field of data. The first such part is the type of data, the second part is the length of the data field, and the third part contains the values for the information transmitted in the packet. Of the common routing protocols, OSPF, ISIS, and BGP describe some of the fields in the form of a type-length-value tuple. This field definition is often abbreviated as “TLV”. While the TLV definition may allow for dynamic packet definitions, the additional bytes add to the amount of information that is sent by the respective protocol.

Link State algorithms flood information about local peers, including their links, associated network routes, and additional information associated with the peer. In 1986, when BGP was designed, concerns over the amount of AS level traffic that could be flooded for an EGP caused BGP to utilize a variant of the distance vector algorithm, referred to as the “path vector algorithm”. The BGP-4 protocols are based on a path vector algorithm that makes initial preferences of the “best route,” according to the distance vector metric, by reference to routing policy. Routing policy sets a metric for determining the “best route”.

Because BGP-4 is a path vector protocol, the convergence time with large numbers of BGP peers or BGP routes can take seconds or tens of seconds. Securing the information in the BGP protocol may take up substantially more traffic to secure the selected route and all the other back-up routes. A variant of BGP which is used to secure the protocol, referred to as S-BGP, typically requires 700% more traffic. Portions of BGP-4 or S-BGP, such as the AS-Path, are repeated in many packets. Thus, these protocols currently pass considerable amounts of redundant information. Thus, there is a need for an Exterior Gateway Protocol (EGP), that can reduce the amount of data passed and processed, and thereby allow the use of link state algorithms for flooding information.

Furthermore, network security was not designed into the IP routing protocols typically deployed today, including OSPF, ISIS, or BGP. Though these protocols utilize MD5 authentication to try to overlay source authentication, this technique does not prevent insertion of bad information by a participating router and replay attacks. Thus, there is an additional need for a protocol which can secure data efficiently, while preventing replay attacks.

### SUMMARY

The invention provides systems and methods for employing “network components” to transmit data in networks. Such network components are designed to:
Reduce the data exchanged in networks by replacing repeating information with identification numbers
Secure data sent in networks at a detailed level of granularity

By reducing the information sent in a network, the network components allow the use of link-state protocols for supporting those network information bases which demand substantial data exchange. The BGP-4 routing infrastructure is one such example of a resource intensive protocol. Furthermore, embodiments of the invention allow individual components to be secured at fine level of granularity, thereby enabling the provision of secure network protocols which scale with increasing amounts of frequently updated data.

Embodiments of the invention also include algorithms to:
Create protocols that employ network components in a network data stream
Replace frequently repeated network components with the transmission of an Instance Identification Numbers (NC-IID)
Secure information transmitted in networks by use of network components
Dynamically adjust network component formats.

In embodiments of the invention, component identification numbers may be either variable length or fixed length. These identifiers, referred to as a Network Component Instance Identification Numbers, or NC-IIDs, indicate a particular set of repeating data transmitted in the network. In embodiments of the invention, the network components may comprise a nested hierarchy of sub-components. In some such embodiments, each sub-component, in turn, is assigned its own NC-IID. In embodiments, nodes may process nested sub-components in recursive fashion. Embodiments of the invention include algorithms to adjust the sizes of IDs dynamically, in response to events such as routing traffic or update signals.

In some embodiments of the invention, the NC-IID is a monotonically increasing sequence number. This feature, coupled with varying aging rates for network components, enables security algorithms to prevent replay attacks. In some such embodiments, a network component may have one or more security sub-components, which, in certain non-limiting embodiments, may periodically request that certain information transmitted via a network be re-secured at its source.

In embodiments of the invention, each network component passes a particular grouping of information in the protocol and is assigned a Global Format Identifier (NC-GFI). In some embodiments, network components are grouped in classes, such that each class of network components has their own time periods for re-transmitting information, re-securing information, and aging information.

The aging process includes the wrap-around of sequence numbers. Classes of network components may contain one or more network components.

Network components may perform particular types of network functions. Examples of such functions may include any one or more of the following types:
Security components, i.e., the use of the network components for passing security information
Policy components, i.e., the use of the component structure for transmitting policy information
IP Route components, i.e., the use of network components for exchanging or otherwise supporting IP routing
IP Switching components, for e.g., the use of the component structure for passing MPLS switching information.

These and other possible functions of network components shall be apparent to those skilled in the art.

### BRIEF DESCRIPTION OF THE FIGURES

FIG. 1 illustrates packet streams in which repeated blocks of information are replaced with network components according to embodiments of the invention.

FIG. 2 illustrates a conversion between formats of network information according to embodiments of the invention.

FIG. 3 illustrates a component architecture used in embodiments of the invention.

### DETAILED DESCRIPTION

A. Introduction

The invention introduces “network components” comprising data structures for communication in packet-switched networks. The network components may be nested in recursive hierarchies, thereby simplifying the algorithms and protocols used to process these components. The use of network components also reduces the information transmitted in a network, thereby enabling the use of link-state protocols for resource-intensive network protocols. Furthermore, the recursive, nested structure of network components enables information flow to be secured at fine level of granularity, thereby mitigating the unwieldy overhead of standard secure protocols.

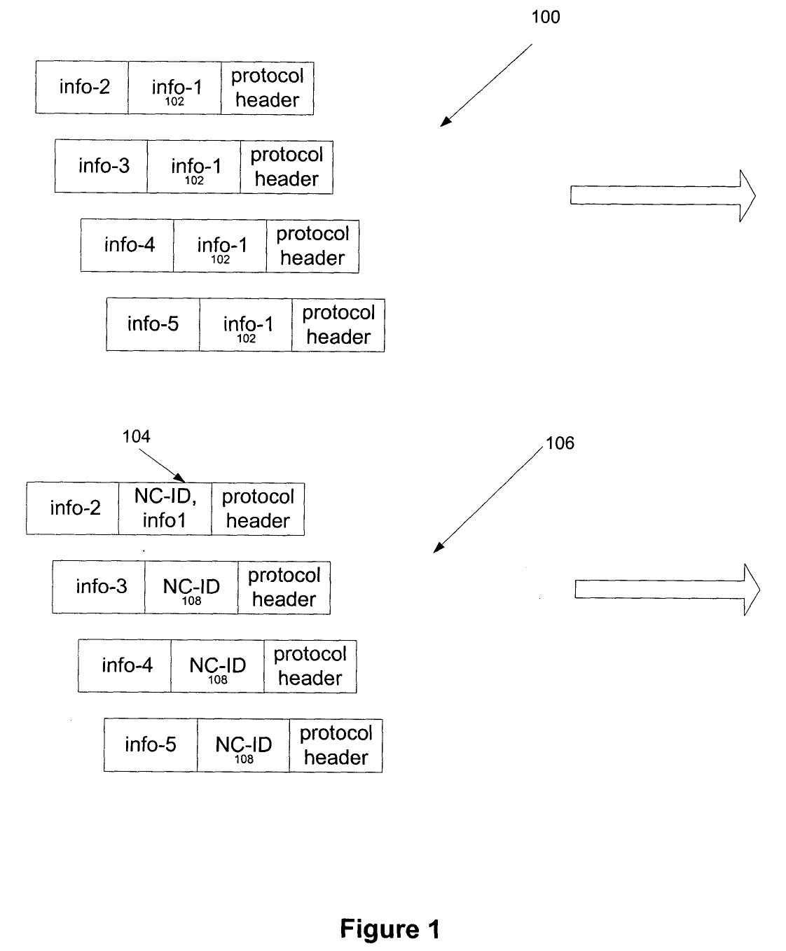

The use of network components to replace repeating and/or redundant data transmitted in a network is illustrated in FIG. 1. A data stream 100 may be encoded in an type of standard protocol, including but not limited to BGP, OSPF, IS-IS, or RIP. A block of information repeated in the stream, labeled “info-1” 102, is replaced by a network component 104. Packet streams 106 containing the repeated block 102 are replaced with compressed packet streams containing the network component identifier 108 in place of the repeated block. As will be apparent to one skilled in the art, the substitution of an identifier for a repeated block 102 allows for compression by a factor better than the log of the length of the repeated block 102.

B. Format of Network Components

In embodiments of the invention, a given network component may be instantiated per a default format, or a custom format forwarded to all relevant network entities. In some embodiments, the formats may be transmitted during an establishment phase of a peer/connection, at which protocol capabilities are negotiated between peers. In embodiments, the formats of certain network components are themselves passed as network components, which are, in turn, defined by their own NC-GFI and their own NC-IID. In some such embodiments, the first such transmission of the format information associates an NC-IID for the respective format. Subsequent peer/connection negotiations need only pass the NC-IID associated with the format.

Embodiments of the invention allow formats of particular network components to be dynamically readjusted. These readjustments may be configured manually by an operator, or derived manually or automatically from an examination of network traffic. In embodiments of the invention, features that may be readjusted include the syntax of a particular network component or information pertaining to a class of components. By way of non-limiting example, the changes to the syntax of a network component may include changes to the sizes and/or format of the network components ID field, length field or data content field. As a further, illustrative, non-limiting example, the component class information that may be dynamically revised may include retransmission time periods, aging periods, wrap processing, and re-securing time periods.

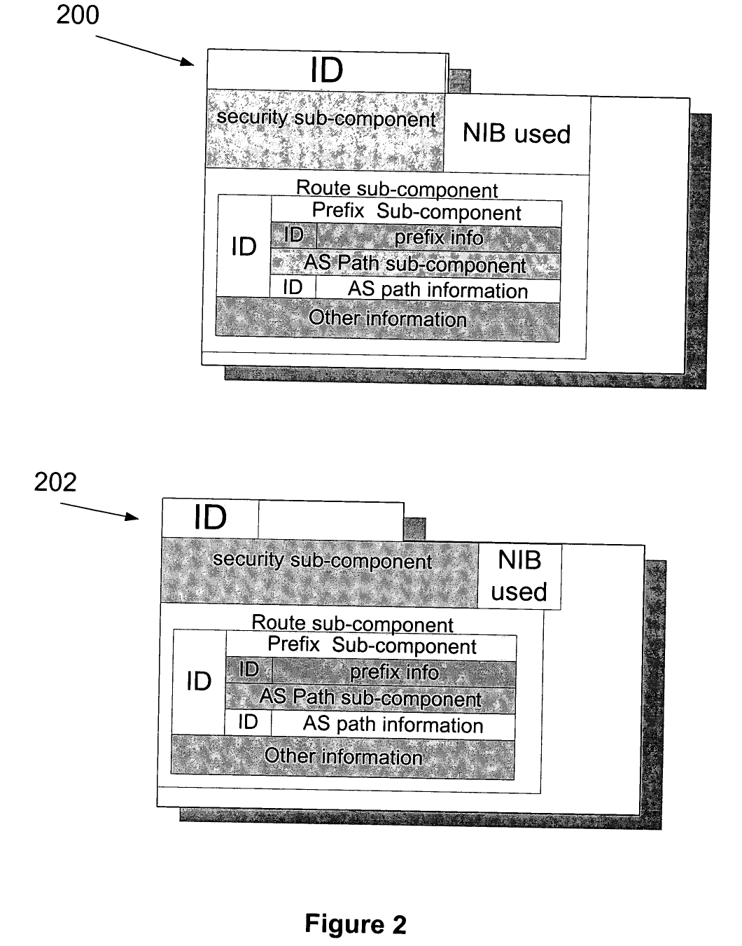

As an illustrative, non-limiting example, FIG. 2 illustrates an IP route component changing from a first format, internal Format 1 200 to a second format, internal Format 2 202. The Global format identifier for the IP Route network component is 00-01-03-07. As illustrated in FIG. 2, differences between Format 1 200 and Format 2 202 include the fields with fixed bytes for ID, security sub-component and NIB sub-component. In this example, a route sub-component is defined to have a variable component size with the length being encoded in the length field.

C. Algorithms to Create Protocols Employing Network Components

Embodiments of the invention include algorithms for creating network components, based on data patterns that are either present in existing protocols or projected for new protocols. An algorithm used to generate network components by embodiments of the invention is presented herein; this algorithm is presented by way of non-limiting example, and many variants, alternatives, and equivalents will be apparent to those skilled in the art.

Step A: Identify the Potential Network Components in the Data Stream.

(Note: the network components algorithms focus on the groupings of the information within a packet or a byte stream. Each grouping of this information is considered a “message” for optimization purposes, and the term “message” is used accordingly in the description below.)

For each protocol (outer-most loop):
1. Initialize a component structure with information about the data stream. Set the level to “protocol level”
2. For each protocol message in the protocol, (message level loop)
   a. create nc_gfi data structure (as described further below) and initialize to zero.
   b. Set the level to message with the level to “message”

c. store the information about the messages type-length-value field in the main component description.

| typedef | _nc_gfi { | | |
|---|---|---|---|
| | nc_level | level; | /* level of GFI */ |
| | gfi_id | nc-gfi; | /* NC-GFI */ |
| | gfi_class | nc-class; | /* class of GFI */ |
| | GA_format | nc-format; | /* format of GFI */ |
| | gfi_format-id | nc-fid; | /* Format id */ |
| | nc_type | type; | /* type byte */ |
| | flag_t | type_flag; | /* type flags */ |
| | nc_length | length; | /* length value */ |
| | flag_t | length_flags; | /* length value */ |
| | nc_value | bytes; | /* bytes of value */ |
| | flag_t | value_type; | /* flag of values */ |

| | |
|---|---|
| GA_byte | non-tlv-bytes; |
| GA_nc_gfi | sub_components_ids; |
| GA_nc_gri | sub_component_stat_start-up; |
| GA_nc_gfi | sub_component_stat_steady_state; |
| GQ_nc_gfi | sub_component_stat_rt_flap; |
| GQ_nc_gfi | sub_component_stat_terminate; |
| GQ_nc_gfi | sub_component_stat_reconfig |

} nc_gfi_protocol;

Where level: 0=stream/protocol
1=message
2 through n=interior hierarchy of components within a data structure
Type-field-flags: implied/actual field, Implied/specified type-field values, Fixed or variable
Length-field-flag: implied/actual field, implied or specified value
Value field: implied/actual, implied or specified, fixed or variable
Sub-component id:
   Level: 0=stream/protocol
      1=message
      2 through N are interior hierarchy

NC-GFIs may be assigned a rank in a hierarchy, and may be interpreted within that scope. However, some NC-GFI are common to “all protocols” or “all messages”.
3. Process the bytes in the message searching for explicitly defined TLV fields or any “implied” TLV fields in each protocol message.
   The identification of any explicitly defined TLV (type length value) fields in a protocol entails examination of protocol definitions to see if type of information is specified, followed by a length, followed by a value. In some protocol, such as IS-IS, the specifications indicate the type-length-value. In other protocol such as BGP, the attribute fields have a “type code”, a length and a set of values that value.
   Implied type-length-value fields are those fields contained within a protocol that are predefined. An example of a pre-defined type field is the withdraw route field in the BGP-4 protocol specification. The withdraw route field is predefined to be the first item following the BGP header in the Update message. The withdraw field format comprises a length followed by a sequence of prefixes in a variable field. Another example is provided by the OSPF standard, which specifies an authentication field in the OSPF packet header. The type of this field is specified, but the length field is predefined to be 64 bytes.
4. For each found TLV (explicit or implicit), perform the following: (TLV level loop)
   a) Process the “non-TLV” bytes since the last TLV in the current nc_gfi structure
      Record the data format of the bytes from the last TLV recorded to the current TLV in an nc_gfi data structure. Flag this group of fields as non-TLV fields. Assign a non-component type NC-GFI to the group of fields. Store this information in the nc_gfi. Store the ID in the sub-components portion of the current nc_gfi structure.
      If this is the message level of the structure, this will store the bytes since the last TLV.
   b) Assign a NC-GFI to the new TLV field
   c) Save the NC-GFI in a sub-component field of the current TLV
   d) Create a nc_gfi data structure for the TLV and store information about the TLV in the data structure. Store the NC-GFI for the TLV as the current sub-component gfi.
   e) Search for any TLV within this components value field. If a TLV is found:
      a. Increment the global nesting count,
      b. Store on a stack, NC_GFI of the current component.
      c. Let the current current-NC_GFI=current sub-component gfi
      d. Execute steps a-d again.
   f) At the end of processing a value field:
      a. Store the bytes not associated with a TLV since the last TLV has been assigned or the beginning of the message as a “non-TLV” network component.
      b. If the level>message level pop the stack of the last store component and execute steps a-e.
   g) If the level=message, go back to item 3 at this step
      Record the component-type-id in the array of sub-components for the current component structure.
      Create another nc_protocol structure with component-type-id number,
      Record the information about protocol
      Search for any nested TLV structures within the value field

An example of a nested TLV field can be found in the withdraw field of the BGP-4 Update packet. The BGP-4 withdraw has two types of implied TLV fields: The withdraw field has an implied “type” followed by a length field, followed by the variable field of prefixes. The format of the prefixes is a one-byte length field followed by the prefix field. The one-byte length field gives the length of the prefix in bits. The prefix field can be 1-4 bytes depending on the value in the prefix length field.

This is an outer implied TLV field. Inside the withdraw TLV field, the repeated implied TLV fields with the prefixes. The type is “withdraw-prefix” which is implied and not passed in the protocol. The length of the prefix and the value field follow. BGP gives us an example of a nested set of TLV fields.
5. If more message bytes are included in the message, return to step 3 to process the rest of the message.
6. If no more bytes are included in this message, see if there is another message type defined by the protocol. If there is not, exit this step. If there is, go back step 3.

Step B: Determine the Number of Times Each Network Component (TLV or non-TLV) will be Transmitted in One of the Modes of Exchange: Start-Up, Reconfiguration, Steady State, Network Oscillations and Termination.

If the protocol implementation exists, evaluate existing data flow traffic to determine the average number of times each network component occurs during the lifetime of network flow. The lifetime of a network flow normally has start-up, steady-state and termination. Certain network flows will be subject to reconfiguration of network paths or devices and network oscillations.

Step C: Record Policy Information for Each Protocol Application on by Querying User, Including:
a) The speed of processing for different portions of a protocol life cycle. The protocol life cycle includes: start-up, steady-state, reconfiguration, termination, and network oscillation.
b) The security standards for the protocol.
c) Specific requests for any field to be an explicit type-length-value NC-IIDs.

Step D: Use the Number of Times a Network Component will be Used to Select between Fixed Format Fields or Explicit Type-Length-Value NC-IID Network Component Fields.
a) Minimize the overall traffic by using fixed format components for information passed frequently in all modes of exchange,
b) If quick processing of network changes is critical to the functioning of the network information base, then use the fixed format components for the information passed during network oscillations.

Step E: Associate the Network Component with a Class of Components. Each Class of Components Share:
Identical re-transmission times to repeat the component information
Identical aging times
Identical ID wrap-around mechanisms
Identical intervals at which to re-secure the information.

Step F: Create Formats to Detail the Format of the Protocol Based on Network Components and the Original Protocol's Design.

A format describes the layout of network-components and non-network component bytes in a protocol in terms of NC-GFI identifiers. The data structure built up in steps A thru E is assigned a format identifier. The original protocols format messages are encoded as a network component.

A format network component is created and the formats created are associated as sub-components. This network component will be attached in step G to peer negotiation messages.

Step G: Associate the New Format Component with the Appropriate Protocols.

IP protocols, routing and switching, utilize a greeting (hello) mechanism to establish the peer, and an extended peer negotiation protocols to add additional capabilities.

In IGP protocols, the hello message is exchanged with preliminary information. In BGP the “hello” mechanism is a “Open” message. In IS-IS there are additional TLV structures for additional router information. In OSPF, Opaque LSAs used at the router level will allow protocols to negotiate additional information. In BGP, the capabilities negotiation can allow new transitive path attributes for BGP-4.

D. Algorithms for Processing Network Components

In embodiments of the invention, peers may exchange network components in their entirety, or may only forward identifiers, or NC-IIDs, for the components. Embodiments of the invention allow either type of stream to be processed, as elaborated below.

In some embodiments, one or more of the following parameters are retained for each network component:
Current component ID
Aging time
ID wrap-around time
ID wrap-count information (including an acceptable 1st NC-IID upon initialization or start-up)
Last time full Component ID information was received
Count of full information retransmissions
Array of error information

To elaborate on the significance of these parameters, the age of a Component ID is the time since the last re-transmission of the information. A component's ID values monotonically increase until the sequence number wraps. The wrap count is the count of the number of wraps. The wrap count timeout denotes a time period for a maximum wrap count number.

A non-limiting example of one such algorithm for processing network components is presented below:
1) Upon receiving a network component, validate that the current network component's NC-iID is either a current NC-IID value or an incremental value. If the NC-IID exceeds permissible values, flag an “out of range ID” to the security portion of the network protocol and terminate the processing of the network component.
2) Determine if the time duration since the component was originally received has exceeded the aging time for this component; determine further if the NC-IID is the original ID value.
   a. If the component has exceeded the aging time and it is using the current ID prior to the wrap-around limit, flag an “over-aged” ID to the security portion of the protocol and terminate processing of network component.
   b. If not, continue processing.
3) By reference to the NC-IID flags, determine if the component was sent in its entirety, or if only the ID of the component was sent
   a. If the component was sent in full:
      i. Validate the security sub-component, component data format and syntax. If it is invalid, then pass the information to the security portion of the protocol.
      ii. Validate the component. If it is invalid, then pass this to the security portion of the protocol.
      iii. If this is not a retransmission, then process the network component. If it is a retransmission, skip the processing.
      iv. Reset the “aging” time on the component to this time, and update the wrap-around processing.
   b. If only the NC-IID was sent,
      v. Validate that the component ID is the current ID and within the age time.
      vi. Refresh the “Aging” time on the component and update the wrap-around processing.
      vii. Linked the process information to the protocol information.
         E. Securing Network Components

In embodiments of the invention, nested network components are secured recursively, from the lowest sub-component level up to the highest level. In some embodiments, each network component supports security by inclusion of one or more of the following:
1) Each network component has a secure sub-component
2) IDs forming sequence numbers for replay attack prevention
3) Retransmission rates per component
4) Aging out timeouts per component
5) Wrap-around count and wrap timeout per component
6) Time periods for requiring re-securing of information
7) Methods for securing information

In some embodiments, one or more network components may comprise part of a class, which shares common parameters, such as, by way of non-limiting example, time outs.

To illustrate the process of securing network components, an algorithm is presented below. Many modifications and/or variants shall be apparent to those skilled in the art:
1. Validate each sub-component of a component (recursively) by:
   a. Validating the sub-component NC-IID for range, age and wrap count.
   b. Secure the sub-sub-component of the sub-component by reference to the sub-component's secure method
   c. Determine if the sub-component's stated retransmission is prior to the next component retransmission time. If the so, schedule the retransmission of the sub-component
   d. Determine if the sub-component's security is prior to the next components re-securing time period. If so, schedule the re-securing of the component.
2. Validate the security of the network component
   a. Validate the NC as a monotonically increasing component, with a valid age and correct wrap count.
   b. If the component is transmitted in full, then use the secure sub-component to determine if the component is valid and secure. If the component is not secure, then send this indication to the protocol. If the component it is secure, then hand this component to the protocol for processing.
   c. If only the Component ID is passed and the ID re-securing time limit or re-transmission limits have been exceeded, then request via the protocol the appropriate a retransmission of the component.
   d. If only the Component ID is passed and the ID does not require re-securing or retransmission, then point the protocol processing to the processed information for this secured ID.
      F. Dynamically Adjustable Network Components

In embodiments of the invention, the structure of each network component is identified with a Global Format Identifier, or NC-GFI. In embodiments, a network component may be associated with multiple format-ids, denoting alternative byte formats for the network component. In some such embodiments, the first transmission of a particular set of data with that format is associated with an NC-IID includes: an ID and set of information. The NC-IID can utilize one of three formats: fixed format, variable length format, or a GFI variable format.

In non-limiting embodiments of the invention, the fixed byte NC-IID transmission uses the 1st bit of the ID field to indicate whether this is the transmission with data or just the NCI-IID. The variable length ID uses the first bit of the 1st length byte to indicate whether the ID is the first transmission or a subsequent. The variable length of the component includes length, followed by ID. The GFI variable format includes: GFI, format-id, length-of ID, ID. The first bit of the length of the ID field uses specifies transmission with data or just ID.

The network component for format structures can either use global pre-defined structures. The Global pre-defined format structures have these levels of support:
Global Components [level 0] (policy, security, NIBs)
Functions based on network type [level 1] (IP, SNA, Novell, Microsoft)
Node function [level 2] (Forwarding, Switching, Routing, Directory)
Components common to classes of network protocols [level 3]
Components for protocols [level 4]
Components for protocol messages [level 5]

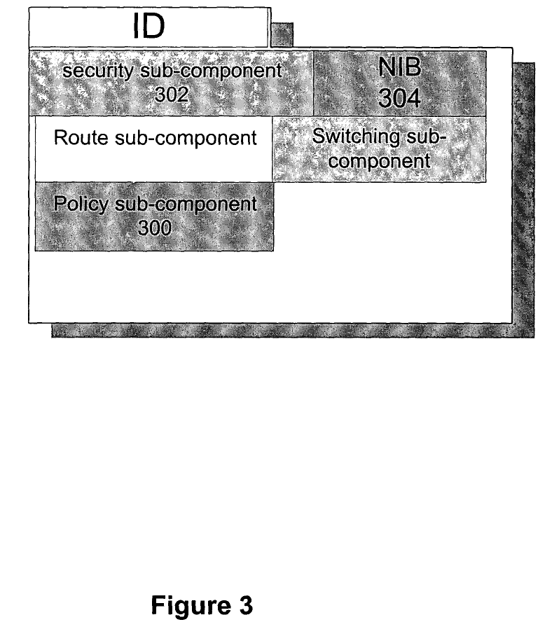

As illustrated in FIG. 3, in embodiments of the invention, the global format components include three sub-components: policy 300, security 302, and network information bases 304. The global policy sub-component may include sub-components for the types of policy defined in a Policy Domain. The sub-components for global policy may include any one or more of the following:
Peer Info
Security Validations component
Security Delegation component
Route Information component
Route Distribution component
Dynamic Route Distribution component
Summarization component
Expansion component, and
Policy Distribution component.

The security format component covers global security information. The network information base format component indicates the type of information passed.

The network component's format information (based on NC-GFI) may include:
1. The NC-GFI that is being formatted
2. length of individual NC-GFI fields
3. Formats associated with the NC-GFI (by format-ids)
4. List of formats to Add/Replace/Delete by format-id
5. Added formats
6. Replaced formats

Each format includes the format of the bytes plus a time range during which the format is valid. The time range includes:
Time this format will be start to be sent
Time this format will stop being sent
Time this format will be accepted
Time this format will stop being accept.

The global GFI data allows the formats to updated asynchronously.

G. Application of Network Components to Assorted Protocols

Embodiments of the invention include an IP Route component, which comprises a global component at level of network classes. The IP route component supports common IP routing information, including static routes, IGPs (RIP, RIPng, OSPF (v2/v3), ISIS), and EGPs (BGP, EGP), Multicast routing (DVMRP, PIM (SM, DM, SSM), and MSDP). Embodiments also include an IP Switching component comprising a global component at the level of a network class. The IP switching component supports MPLS switching and forwarding state for MPLS static routes and MPLS protocols. The policy component is a global level component supporting policies across all classes of network protocols.

H. Conclusion

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method of validating a message encoded according to a network protocol, the message including a plurality of subcomponents arranged in a hierarchy, the method comprising:
receiving the message at a node in a network, wherein the network is operative to communicate via the protocol;
recursively validating each subcomponent of the plurality of subcomponents, recursively validating each subcomponent further including
determining an aging limit for each of the plurality of subcomponents,
determining a sequential identifier for each of the plurality of subcomponents,
determining a wrap-around count for the subcomponent, and
for each of the plurality of subcomponents, comparing the sequential identifier to wrap count for the subcomponent, and the aging limit to a current time.

2. The method of claim 1, further comprising:
if, for a subcomponent of the plurality of subcomponents, the current time exceeds the aging limit and the if the sequential identifier is less than the wrap count, flagging the subcomponent as exceeding the age limit.

3. The method of claim 2, further comprising:
upon flagging the subcomponent, indicating the flagging to a security daemon of the network protocol.

4. The method of claim 1, further comprising:
determining if the subcomponent has been retransmitted.

5. The method of claim 1, wherein the network protocol is a routing protocol.

6. The method of claim 5, wherein the routing protocol is an Exterior Gateway Protocol (EGP).

7. The method of claim 6, wherein the EGP is a path vector protocol.

8. The method of claim 7, wherein the path vector protocol is a version of Border Gateway Protocol.

9. The method of claim 5, wherein the routing protocol is a link state protocol.

10. The method of claim 9, wherein the link state protocol is Open Shortest Path First (OSPF).

11. The method of claim 9, wherein the link state protocol is IS-IS.

12. A method of processing a network component at a first node in an inter-network, the network component representing a block of information encoded in a protocol and transmitted through the inter-network, the method comprising:
communicating the network component to the first node from a second node via the inter-network;
determining an identifier of the network component;
validating the identifier, validating the identifier further including determining a range for the identifier, a wrap count for the identifier, and an age limit for the identifier;
determining whether the network component was exactly one of (1) forwarded in its entirety by the second node to the first node and (2) forwarded in the form of the identifier by the second node to the first node.

13. The method of claim 12, further comprising:
if the network component was forwarded in its entirety, recursively validating one or more subcomponents of the network component.

14. The method of claim 13, wherein recursively validating the one or more subcomponents further includes validating a format for each of the plurality of subcomponents.

15. The method of claim 14, wherein recursively validating the one or more subcomponents further includes validating a syntax for each of the plurality of subcomponents.

16. The method of claim 15, wherein the syntax is at least partially specified by the network protocol.

17. The method claim 15, further comprising:
if a subcomponent from the plurality of subcomponents is invalid, indicating invalidity of the subcomponent to a security daemon in the network protocol.

18. The method of claim 14, further comprising determining if the network component has been retransmitted.

19. The method of claim 15, further comprising:
upon recursively validating the one or more subcomponents, resetting an aging time for the network component.

20. The method of claim 16, further comprising:
upon recursively validating the one or more subcomponents, updating a wrap around processing of the sequential identifier.

21. The method of claim 12, wherein the sequential identifier is monotonically increasing, modulo a wrap around limit for the subcomponent.

22. The method of claim 13, wherein the network protocol is an EGP.

23. The method of claim 22, wherein the EGP is a path vector protocol.

24. The method of claim 23, wherein the path vector protocol is a version of BGP.

25. The method of claim 13, wherein the network protocol is a link state protocol.

26. The method of claim 13, wherein the link state protocol is OSPF.

27. The method of claim 13, wherein the link state protocol is IS-IS.

28. A network component resident on an internetwork, the network component representing a common message transmitted in the internetwork via a communications protocol, the network component comprising:
a plurality of subcomponents arranged in a recursive hierarchy;
an identifier for each subcomponent of the plurality of subcomponents, such that for each subcomponent, the identifier is monotonically increasing for each transmission of each subcomponent, modulo a wrap around limit, wherein the wrap around limit indicates a maximum possible value of the identifier;
a transmission period for each respective subcomponent of the plurality of subcomponents, the transmission period designating a interval for retranslating the subcomponent in the internetwork, such that the respective subcomponent has transmission period less than or equal to a transmission period of one or more parent subcomponents from the plurality of subcomponents;
wherein one or more nodes in the internetwork are operative to validate the plurality of subcomponents by reference to the identifier and wrap around limit of each of the plurality of subcomponents, and the one or mode nodes are operative to increment the identifier of each of the plurality of subcomponents upon retransmission.

29. The network component of claim 28, further including an aging limit, such that the one or more nodes are operative to reset the identifier if a current time exceeds or equals the aging limit.

30. The network component of claim 28, wherein the communications protocol is an EGP.

31. The network component of claim 30, wherein the EGP is a path vector protocol.

32. The network component of claim 31, wherein the path vector protocol is BGP.

33. The network component of claim 29, wherein the communications protocol is a link state protocol.

34. The network component of claim 33, wherein the link state protocol is OSPF.

35. The network component of claim 34, wherein the link state protocol is IS-IS.

36. The network component of claim 29, wherein the one or more nodes are operative to reset an aging metric for each of the plurality of network components.

37. A packet transmitted in an inter-network, the packet comprising: Lk a plurality of component blocks in the packet arranged in a recursive hierarchy;
a first component block in the recursive hierarchy, the first component block including
a first field indicating a rank of the first network component in the recursive hierarchy,
a second field including a unique global identifier for the first component; wherein the first network component substitutes for a first data pattern which has previously traversed the inter-network, such that the first network component is substantially shorter than the first data pattern.

38. The packet of claim 37, wherein the first data pattern encodes a message in an inter-network protocol.

39. The packet of claim 38, wherein the inter-network protocol is a link state protocol.

40. The packet of claim 39, wherein the link state protocol is IS-IS.

41. The packet of claim 39, wherein the link state protocol is a Shortest Path First protocol.

42. The packet of claim 41, wherein the link state protocol is an Open Shortest Path First protocol.

43. The packet of claim 38, wherein the inter-network protocol is a path vector protocol.

44. The packet of claim 38, wherein the inter-network protocol is a distance vector protocol.

45. The packet of claim 37, wherein the first data pattern encodes a series of parameters which appear frequently in packet headers communicated in the inter-network.

46. The packet of claim 37, further comprising:
a second component in the recursive hierarchy, the second component embedded in the first component, the second component substituting for a second data pattern which has previously traversed the inter-network.

47. The packet of claim 46 further comprising:a third field indicating a rank of the second network component in the recursive hierarchy,
a fourth field including a unique global identifier for the second component.

48. The packet of claim 47, wherein the rank of the second network component is lower than a rank of the first network component.

49. A method of transmitting a packet in an inter-network, the packet including a plurality of components, each of the plurality of components comprising a block of packet information, the method comprising:
at a first peer in the inter-network, receiving the packet:
identifying a first component in the plurality of components, wherein the first component is encoded in a default format, such that the first peer is operative to decipher the default format, identifying the default format further including identifying a global format identifier for the default format, wherein the global format identifier for the default format is embedded in the first component;
processing the first component at the first peer by reference to the default format;
determining a second format encoded by the first component, such that the second format was not previously stored in the first peer;
identifying a second component from the plurality of components, the second component recursively embedded in the first component, the second component compressing a block of network information frequently repeated in the inter-network, identifying the second component further including identifying a global format identifier for the second format, wherein the global format identifier for the second format is embedded in the second component.
decompressing the second component at the first peer by reference to the second format.

50. The method of claim 49, wherein the first and second peers are located in separate autonomous systems.

51. The method of claim 50, wherein the first and second peers are in communication via an Exterior Gateway Protocol.

52. The method of claim 51, wherein the Exterior Gateway Protocol is Border Gateway Protocol.

53. The method of claim 49, wherein the first and second peers are in a single autonomous system.

54. The method of claim 53, wherein the first and second peers are in communication via an Interior Gateway Protocol.

55. The method of claim 49, wherein the first and second peers are in communication via a distance vector protocol.

56. The method of claim 49, wherein the first and second peers are in communication via a link state protocol.

57. The method of claim 49, wherein the first and second peers are in communication over one of the group consisting of RIP, OSPF, ISIS.

58. The method of claim 49, further comprising:
assigning a unique identifier for the second network component.

59. The method of claim 58, wherein the unique identifier is monotonically increasing.

60. The method of claim 59, further comprising:
substituting the unique identifier of the second network component for the second network component in subsequent transmissions in the inter-network.

61. The method of claim 60, wherein the identifier of the second network component is significantly shorter the second network component itself.

62. The method of claim 49, wherein the block of network information includes a parameters frequently transmitted in packet headers through the inter-network.

63. A method of transmitting network information in a network, the method comprising:
identifying a pattern of network data frequently repeated within packets traversing the network;
generating a packet component to substitute for the packet of network data, generating the packet component including generating a unique, monotonically increasing identifier for the packet component;
transmitting the packet component embedded in a packet in the inter-network, wherein the packet component substitutes for the pattern of network data;
in place of the packet component, subsequently transmitting only the unique identifier to substitute for the pattern of network data, wherein the unique identifier is substantially shorter than the packet component.

64. The method of claim 63, wherein the network is a local area network.

65. The method of claim 63, wherein the network is an autonomous system.

66. The method of claim 63, wherein the network is an inter-network.

67. The method of claim 63, wherein the pattern of network data includes routing information.

68. The method of claim 67, wherein the routing information includes parameters in a routing protocol.

69. The method of claim 68, wherein the routing protocol is a link state protocol.

70. The method of claim 68, wherein the routing protocol is a distance vector protocol.

71. The method of claim 68, wherein the routing protocol is a path vector protocol.

72. The method of claim 63, wherein the pattern of network data includes information from a network security application.

73. The method of claim 72, wherein the network security application is a firewall.

74. The method of claim 72, wherein the network security application is a virtual private network (VPN) application.

75. The method of claim 38, wherein the VPN application is an IPSec application.

76. The method of claim 72, wherein the network security application is a Secure Socket Layer application.

77. The method of claim 63, wherein the pattern of network data includes information from a network monitoring application.

78. The method of claim 77, wherein the network monitoring application is based on Simple Network Monitoring Protocol.

79. The method of claim 63, wherein the pattern of network data includes information encoded in a communications protocol.

80. The method of claim 79, wherein the communications protocol is Simple Object Access Protocol.

81. The method of claim 79, wherein the communications protocol is a Common Object Request Broker Application.

82. The method of claim 63, wherein the pattern of network data is encoded in XML.
